(19) United States
(12) Patent Application Publication
(10) Pub. No.: US 2010/0275480 A1
(43) Pub. Date: Nov. 4, 2010

(54) ASSEMBLY OF A SIGN BOARD

(76) Inventor: Ki Ryong Kim, Changwon-si (KR)

Correspondence Address: CHRISTOPHER PAUL MITCHELL, 888 16TH ST., NW, SUITE 800, WASHINGTON, DC, 20006, US

(21) Appl. No.: 12/526,498

(22) PCT Filed: Feb. 11, 2008
(86) PCT No.: PCT/KR2008/000784

§ 371 Date: Aug. 7, 2009

(30) Foreign Application Priority Data
Feb. 8, 2007 (KR) 10-2007-0013116

(51) Int. Cl. G09F 15/00

(52) U.S. Cl. 40/606.01

(57) ABSTRACT

The present invention provides a signboard assembly, which is constructed such that, when external force is applied to a signboard, the signboard is rotated, and, when the external force is removed therefrom, the signboard is automatically returned to its original position. The signboard assembly includes the signboard (20) for expressing information, a support unit (30), which rotatably supports the signboard, an elastic member (58), which applies elastic force to the support unit to return the support unit to its original position, and a weight member (80), which maintains the original installation position of the signboard. The signboard assembly of the present invention having the above-mentioned construction is advantageous in that, even if a relatively large external force is applied to the signboard, the signboard is prevented from being damaged and is easily returned to its original position.

### TECHNICAL FIELD

The present invention relates, in general, to signboard assemblies and, more particularly, to a signboard assembly which is constructed such that, when external force is applied to a signboard, the signboard is rotated, and, when the external force is removed therefrom, the signboard is automatically rotated back to its original position.

### BACKGROUND ART

Generally, signboards are provided around roads to indicate traffic information or passage conditions to travelers such that they can safely travel.

Signboards increase the convenience of travel for vehicles and pedestrians convenient. Such signboards are installed by various methods. For example, signboards may be provided on crossbars, which extend from the upper ends of vertical poles, which are placed upright at intersections, perpendicular thereto in horizontal directions. In addition, signboards may be directly mounted to vertical poles placed along roads and provide traffic information to drivers or pedestrians.

However, there have been many cases where the conventional signboards are damaged by external impacts, such as collision of vehicles, or by high wind pressure. That is, parts of the conventional signboards are solidly fastened to each other, so that each of the parts has no play.

Therefore, when external force is applied to the signboards, signboard assemblies, including the signboards or the supports therefor, are bent or damaged. In other words, because the conventional techniques have no shock-absorbing structure, when some external force is applied to the signboards, the signboard assemblies may be easily damaged.

As such, the conventional signboard assemblies are problematic in that, because the parts thereof are solidly fastened to each other, when they are bent or damaged by external force, the signboards cannot conduct the intended purpose thereof.

### DISCLOSURE OF INVENTION

### Technical Problem

Accordingly, the present invention has been made keeping in mind the above problems occurring in the prior art, and an object of the present invention is to provide a signboard assembly, in which a signboard is rotatably supported by a support unit.

Another object of the present invention is to provide a signboard assembly, which is constructed such that, even when the signboard is moved, the signboard can be returned to its original position thanks to an elastic member and an auxiliary elastic unit.

A further object of the present invention is to provide a signboard assembly, in which a weight member is provided on the lower end of the signboard to maintain the original installation position of the signboard.

### TECHNICAL SOLUTION

In order to accomplish the above objects, in an aspect, the present invention provides a signboard assembly, including: a signboard for indicating an information; a support unit for rotatably supporting the signboard; an elastic member for applying an elastic force to the support unit to return the support unit to an original state thereof, and an auxiliary elastic unit provided on the support unit to apply an elastic force to the support unit to return the support unit to an original position thereof.

Preferably, the support unit may include: a clamp unit fastened to a crossbar; and a coupling member coupled to the clamp unit so as to be rotatable, the coupling member being coupled at an end thereof to the signboard.

The signboard assembly may further include a soft member provided between the clamp unit and the crossbar. The soft member may have a predetermined elasticity and surround the crossbar.

The signboard assembly may further include an auxiliary elastic unit provided at a predetermined position on the support unit to apply an elastic force to the support unit to return the support unit to an original position thereof.

In another aspect, the present invention provides a signboard assembly, including: a signboard for indicating an information; a support unit for rotatably supporting the signboard; an elastic member to apply an elastic force to the support unit to return the support unit to an original position thereof; and a weight member provided on a lower end of the signboard to maintain an original installation position of the signboard.

The support unit may include: a clamp unit fastened to a crossbar; a coupling member coupled to the clamp unit so as to be rotatable, the coupling member being coupled at an end thereof to the signboard; and a soft member provided between the clamp unit and the crossbar, the soft member being made of an elastic material.

The signboard assembly may further include an auxiliary elastic unit provided at a predetermined position on the support unit to apply an elastic force to the support unit to return the support unit to an original position thereof.

The elastic member may comprise an elastic spring.

The clamp unit may include: an upper clamp provided at an upper position; and a lower clamp provided at a lower position, wherein the upper clamp and the lower clamp are coupled at one ends thereof to each other by a hinge.

In a further aspect, the present invention provides a signboard assembly, including: a signboard for indicating an information; a support unit for rotatably supporting the signboard; and a weight member provided on the signboard to maintain an original installation state of the signboard.

The weight member may be removably mounted to a lower end of the signboard.

In the signboard assembly of the present invention, even if external force is applied to the signboard, the signboard assembly is prevented from being damaged. In addition, there is an advantage in that the signboard, after having been rotated, can be automatically returned to its original position.

### ADVANTAGEOUS EFFECTS

A signboard assembly according to the present invention includes a signboard, which indicates traffic information, and a support unit, which supports the signboard. Here, the support unit rotatably supports the signboard. Therefore, the present invention has an advantage in that, when external force, for example, wind or the collision of a vehicle, is applied to the signboard, the signboard is rotated, thus preventing the signboard from being damaged.

Furthermore, the signboard assembly further includes an elastic member and an auxiliary elastic unit, which apply elastic force to the signboard assembly such that the signboard, which has been moved (rotated), can be returned to its original position. Hence, when a relatively small external force is applied to the signboard, the signboard assembly maintains the signboard in its original position. Even if the signboard is rotated by a relatively large external force, the signboard assembly can return the signboard to its original position thanks to the elastic force of the elastic member.

In addition, in the signboard assembly of the present invention, a weight member for increasing the load of the signboard may be optionally provided on the signboard. In this case, the load of the lower end of the signboard is increased, so that the signboard is prevented from being easily moved by external force, and, even when the signboard is rotated by external force, the signboard can be rapidly returned to its original state when the external force is removed therefrom.

As such, in the present invention, when a relatively large external force, which is induced by wind or the collision of a vehicle, is applied to the signboard, the signboard is rotated, so that the signboard assembly is prevented from being damaged. When the external force is removed, the signboard is rapidly returned to its original state. Therefore, the present invention is advantageous in that maintenance costs are reduced, and the signboard can continue to serve its intended purpose.

The features and advantages of the present invention will be more clearly understood from the following detailed description with reference to the attached drawings. The terms and words used in the specification and claims are not necessarily limited to typical or dictionary meanings, but must be understood to indicate concepts selected by the inventor as the best method of illustrating the present invention, and must be interpreted as having meanings and concepts adapted to the scope and sprit of the present invention for understanding the technology of the present invention.

### BRIEF DESCRIPTION OF THE DRAWINGS

FIG. 1 is a left side view showing the installation of a preferred embodiment of a signboard assembly according to the present invention;

FIG. 2 is a rear view showing a signboard constituting the signboard assembly according to the present invention;

FIG. 3 is a sectional view taken along the line I-I′ of FIG. 2;

FIG. 4 is a partially broken rear perspective view illustrating the construction of the lower end of the signboard according to the embodiment of the present invention;

FIG. 5 is an exploded perspective view illustrating the construction of a support unit according to the embodiment of the present invention;

FIG. 6 is an exploded perspective view showing another embodiment of a support unit according to the present invention;

FIG. 7 is a rear view of another embodiment of the signboard constituting the signboard assembly according to the present invention; and

FIG. 8 is a sectional view taken along the line J-J′ of FIG. 7.

### DESCRIPTION OF THE ELEMENTS IN THE DRAWINGS

10. signboard assembly 12. crossbar

20. signboard 30. support unit

32. clamp unit 34. soft member

36. coupling member 46. first hinge shaft

54. second hinge shaft 58. elastic member

60. mounting rail 70. auxiliary elastic unit

80. weight member

### BEST MODE FOR CARRYING OUT THE INVENTION

Hereinafter, a preferred embodiment of the present invention will be described in detail with reference to the attached drawings.

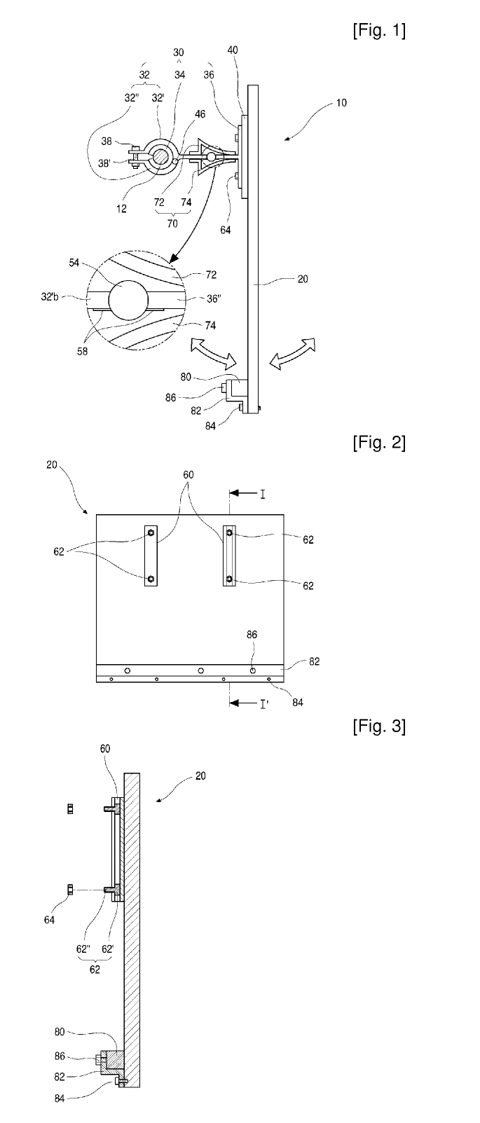

FIG. 1 is a left side view showing a preferred embodiment of a signboard assembly mounted to a crossbar, according to the present invention.

FIG. 2 is a rear view of a signboard constituting the present invention. FIG. 3 is a sectional view taken along the line I-I′ of FIG. 2.

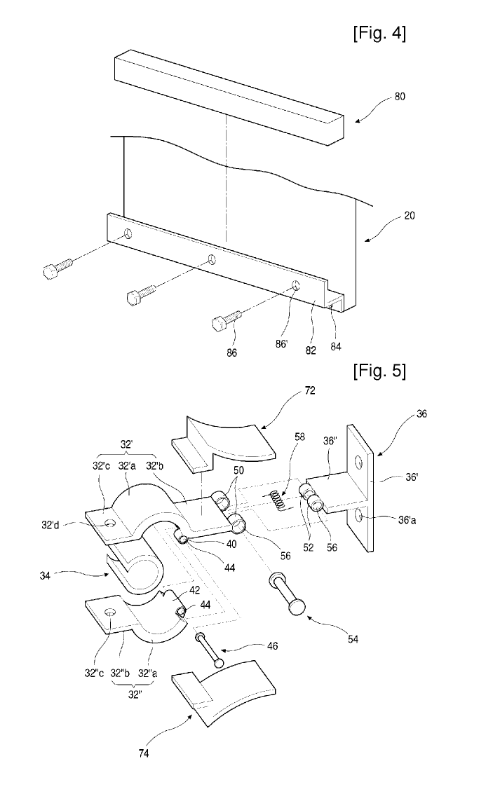

FIG. 4 is a partially broken perspective view illustrating the construction of the lower end of the signboard according to the present invention. FIG. 5 is an exploded perspective view illustrating the construction of a support unit according to the present invention.

As shown in the drawings, the signboard assembly 10 according to the present invention is mounted to the crossbar 12, which is disposed at a roadside or above a road. That is, typically, a vertical support pole (not shown) having a predetermined length is placed upright on a roadside, and the crossbar 12 is provided on the upper end of the vertical support pole so as to be parallel to a road surface.

The signboard assembly 10 is mounted to the crossbar 12 to provide traffic information to drivers or pedestrians.

The signboard assembly 10 includes the signboard 20, on which traffic information is marked to provide driving or walking information to drivers or pedestrians, support units 30, which rotatably support the signboard 20, elastic members 58, which apply elastic force to the corresponding support units 30 such that the support units 30 are returned to the original states thereof, and a weight member 80, which is provided on the lower end of the signboard 20 to return the signboard 20 to its originally installed position.

The signboard 20 may comprise a plurality of layers, including a printed film, but this is not shown in the drawings in detail. The signboard 20 expresses driving or walking information using letters or figures, and has various shapes, for example, a circular shape or a triangular shape. In the present invention, an example in which a rectangular plate is used as the signboard 20 will be given.

The support units 30 serve to mount the signboard 20 to the crossbar 12 provided on the road. Each support unit 30 consists of a plurality of parts. In detail, the crossbar 12 is typically made of a rod having a predetermined thickness, and the support units 30 are fitted over such a crossbar 12. The signboard 20 is fastened to ends of the support units 30.

The signboard 20 is provided so as to be rotatable around the crossbar using the support units 30. Furthermore, the signboard 20 is constructed such that it can be returned to the original position thereof thanks to elasticity. In detail, the signboard 20 is constructed such that, when a vehicle strikes it, or some other external force, such as wind, is applied thereto, the signboard 20 is rotatable, and, when the external force is removed therefrom, the signboard 20 can be returned to its original state.

Meanwhile, mounting rails 60 are vertically provided on the rear surface (the left side surface as seen in FIG. 1) of the signboard 20, such that the ends (the right ends as seen in FIG. 1) of the support units 30 can be coupled at desired positions to the signboard 20 by respective mounting rails 60.

In detail, as shown in FIGS. 2 and 3, the two mounting rails 60 are vertically provided at left and right positions, respectively, on the upper part of the rear surface (the front surface when seen in FIG. 2) of the signboard 20.

Each mounting rail 60 has a shape which is open on the front end thereof (when seen in FIG. 2). A pair of locking bolts 62 is fitted into each mounting rail 60. That is, as shown in the drawing, heads 62′ of the locking bolts 62 are inserted into each mounting rail 60 and are disposed at positions adjacent to the upper end and the lower end of the mounting rail 60, respectively.

Screw parts 62″ of the locking bolts 62 protrude forwards (leftwards when seen in FIG. 3) from the front end of the mounting rail 60. A locking nut 64 is tightened over the screw part 62″ of each locking bolt 62. That is, the screw parts 62″ of the locking bolts 62 pass through a corresponding coupling member 36, which will be explained later herein, and the locking nuts 64 are thereafter tightened over the respective screw parts 62″ of the locking bolts 62.

As such, the head 62′ of each locking bolt 62 is inserted into the corresponding mounting rail 60 through the upper or lower end thereof downwards or upwards in a sliding manner, and is disposed at a predetermined position. Therefore, stoppers, to which the corresponding heads 62′ of the locking bolts 62 are locked, are preferably provided in the mounting rail 60, although they are not shown in the drawings.

Meanwhile, the weight member 80 is provided on the lower end of the rear surface (the left side surface when seen in FIG. 1) of the signboard 20. The weight member 80 serves to weigh down the lower end of the signboard 20, and is thus preferably made of relatively heavy material, such as metal.

Furthermore, preferably, the present invention is constructed such that the weight member 80 can be optionally provided on the lower end of the signboard 20. To achieve this purpose, a weight member bracket 82, into which the weight member 80 is optionally seated, is provided on the lower end of the signboard 20.

As shown in FIG. 1, the weight member bracket 82 has an ‘L’-shaped cross-section. Thus, the weight member 80 is inserted into the weight member bracket 82 through the upper end or one of the opposite ends thereof (through the front or rear end thereof when seen in FIG. 1).

The lower end of the weight member 80 is fastened to the lower end of the signboard 20 using a plurality of coupling screws 84. As shown in FIG. 4, a plurality of locking screws 86 is inserted into the weight member bracket 82. The locking screws 86 serve to hold the weight member 80, which is seated into the weight member bracket 82. To achieve this purpose, a plurality of screw holes 86′, into which the respective locking screws 86 are tightened, is formed through the weight member bracket 82.

When seen in FIG. 1, the support unit 30 is disposed on the left side surface of the signboard 20 to support the signboard 20. The support unit 30 includes a clamp unit 32, which is fastened to the crossbar 12, a soft member 34, which is interposed between the clamp unit 32 and the crossbar 12 and is made of elastic material, and the coupling member 36, which is coupled at one end thereof to the signboard 20.

The clamp unit 32 comprises a pair of parts, and is constructed such that the parts surround the circumferential outer surface of the crossbar 12. In detail, the clamp unit 32 includes an upper clamp 32′, which surrounds the upper part of the crossbar 12, and a lower clamp 32″, which surrounds the lower part of the crossbar 12.

The upper clamp 32′ includes an upper crossbar holding part 32′a, which surrounds the circumferential outer surface of the upper part of the crossbar 12, and an upper extension part 32′b, which extends from a right end of the upper crossbar holding part 32′a rightwards. The upper clamp 32′ further includes an upper clamp coupling part 32′c, which extends from a left end of the upper crossbar holding part 32′a leftwards.

The lower clamp 32″ includes a lower crossbar holding part 32″a, which surrounds the circumferential outer surface of the lower part of the crossbar 12, and a lower clamp coupling part 32″b, which extends leftwards from a left end of the lower crossbar holding part 32″a.

The upper crossbar holding part 32′a and the lower crossbar holding part 32″a are symmetrically arranged. That is, the upper crossbar holding part 32′a and the lower crossbar holding part 32″a have semicircular cross-sections corresponding to the upper half and the lower half of the crossbar 12, respectively.

The upper clamp coupling part 32′c and the lower clamp coupling part 32″b serve to fasten the left end of the upper clamp 32′ and the left end of the lower clamp 32″ to each other. The upper and lower clamp coupling parts 32′c and 32″b are coupled to each other using a coupling bolt 38 and a coupling nut 38′. For this, an upper coupling hole 32′d, into which the coupling bolt 38 is inserted, is formed through the upper clamp coupling part 32′c, and a lower coupling hole 32″c, into which the coupling bolt 38 is inserted, is formed through the lower clamp coupling part 32″b.

Furthermore, the lower clamp 32″ is coupled to the upper clamp 32′ by a hinge. That is, the right end of the lower clamp 32″ is rotatably coupled to the upper clamp 32′ by the hinge.

In detail, as shown in the drawings, first hinge bushes 40 are provided on the left end of the lower surface of the extension part 32′b of the upper clamp 32′. A second hinge bush 42 is provided on the right end of the lower clamp 32″, and is disposed between the first hinge bushes 40.

In addition, respective first hinge holes 44 having a predetermined diameter are formed through the first hinge bushes 40 and the second hinge bush 42. A first hinge shaft 46 having a predetermined length is inserted into the first hinge holes 44. The first hinge shaft 46 serves as the center of rotation of the lower clamp 32″.

As such, thanks to the structure in which the lower clamp 32″ is rotatably coupled to the upper clamp 32′ by the hinge, the installation of the upper clamp 32′ and the lower clamp 32″ on the crossbar 12 is facilitated. In detail, the lower clamp 32″ is rotated around the first hinge shaft 46 in the direction in which it is opened, and, thereafter, the crossbar 12 is disposed between the lower clamp 32″ and the upper clamp 32′. Subsequently, the left end of the upper clamp 32′ and the left end of the lower clamp 32″ are fastened to each other using the coupling bolt 38 and the coupling nut 38′.

Here, the soft member 34 is disposed between the upper clamp 32′ and the lower clamp 32″. The soft member 34 is an elastic member, such as rubber, and surrounds the circumferential outer surface of the crossbar 12. The soft member 34 has a predetermined thickness. The soft member 34 has a circular ring shape or, as shown in the drawing, a partially cut ring shape (in FIG. 5, a left part thereof is cut).

The soft member 34 is used to firmly fasten the clamp unit 32 to the crossbar 12 and prevent slipping therebetween. Furthermore, the soft member 34 makes it possible to fasten the clamp unit 32 to the crossbar 12 regardless of the diameter of the crossbar 12.

The coupling member 36 includes a signboard coupling part 36′, which extends a predetermined length in the vertical direction, and is mounted to the signboard 20, and a connection part 36″, which perpendicularly extends from the medial portion of the signboard coupling part 36′ leftwards.

In detail, the signboard coupling part 36′ is coupled to the corresponding mounting rail 60, which is provided on the rear surface (the left side surface when seen in FIG. 1) of the signboard 20. That is, the signboard coupling part 36′ is brought into close contact with and is fastened to the corresponding mounting rail 60, and serves to support the signboard 20. For this, coupling holes 36′a, into which the screw parts 62″ of the corresponding locking bolts 62 are inserted, are formed through the centers of the upper part and the lower part of the signboard coupling part 36′, respectively.

The coupling member 36 is disposed on the right (when seen in FIG. 1) of the clamp unit 32, and is rotatably coupled to the clamp unit 32. In other words, the left end of the coupling member 36 is coupled to the right end of the clamp unit 32 by a hinge.

To achieve the above purpose, as shown in the drawings, third hinge bushes 50 are provided on the right end of the upper clamp 32′. Fourth hinge bushes 52, which are disposed between the third hinge bushes 50, are integrally provided on the left end of the connection part 36″.

Furthermore, a second hinge shaft 54 having a predetermined length is inserted into the third hinge bushes 50 and the fourth hinge bushes 52. For this, second hinge holes 56, into which the second hinge shaft 54 is rotatably inserted, are formed through the centers of the third hinge bushes 50 and the fourth hinge bushes 52, respectively.

The second hinge shaft 54 serves as the center of rotation of the coupling member 36 and the signboard 20, and has a cylindrical shape. As shown in the drawings, preferably, the second hinge shaft 54 has on each of the opposite ends thereof an increased-diameter part, which has a diameter greater than that of the medial part of the second hinge shaft 54 to prevent removal of the second hinge shaft 54.

The elastic member 58 is fitted over the second hinge shaft 54. As shown in the drawings, the elastic member 58 is made of an elastic spring. The opposite ends of the elastic member 58 are supported by the clamp unit 32 and the coupling member 36, respectively.

In detail, the right end of the elastic member 58, which is made of the elastic spring, is attached and fastened to the lower surface of the connection part 36″ of the coupling member 36, and the left end of the elastic member 58 is attached and fastened to the lower surface of the extension part 32′b of the upper clamp 32′. Of course, the opposite ends of the elastic member 58 may be fastened to the respective upper surfaces of the clamp unit 32 and the coupling member 36, or, alternatively, they may be inserted into and thus fastened to the clamp unit 32 and the coupling member 36, respectively.

The support unit 30 further includes an auxiliary elastic unit 70. The auxiliary elastic unit 70 serves to provide elastic force to the support unit 30 along with the elastic member 58 such that the support unit 30 can be returned to its original position. That is, the auxiliary elastic unit 70 serves to assist the function of the elastic member 58.

As shown in the drawings, the auxiliary elastic unit 70 includes an upper auxiliary elastic member 72 and a lower auxiliary elastic member 74, which are symmetrically arranged. Therefore, the auxiliary elastic unit 70 has a shape like a clamp. The auxiliary elastic unit 70 is fastened to the clamp unit 32 and supports the coupling member 36.

In detail, as shown in the drawings, left ends of the auxiliary elastic unit 70 are fixed to the upper and lower surfaces of the extension part 32′b of the upper clamp 32′ by welding or the like, respectively. Right ends of the auxiliary elastic unit 70 are in contact with the upper and lower surfaces of the connection part 36″ of the coupling member 36, respectively. Here, the right ends of the auxiliary elastic unit 70 merely contact the upper and lower surfaces of the connection part 36″ of the coupling member 36, but are not fixed thereto. Hence, the right ends of the auxiliary elastic unit 70 are slidable with respect to the upper and lower surfaces of the connection part 36″ of the coupling member 36.

Preferably, the auxiliary elastic unit 70 is made of material such as metal, which itself has predetermined elasticity. Therefore, the auxiliary elastic unit 70 and the elastic member 58 serve to prevent upward or downward movement of the coupling member 36 using elastic force attributable to the shapes thereof and the characteristics of the material thereof. Furthermore, when the coupling member 36 is undesirably moved upwards or downwards, the auxiliary elastic unit 70 and the elastic member 58 apply elastic force to the coupling member 36 to return the coupling member 36 to its original position.

The operation of the present invention having the above-mentioned construction will be described herein below with reference to FIGS. 1 through 5.

It is preferable that the signboard 20 and the support unit 30 be manufactured through separate processes. In detail, the signboard 20 having a rectangular planar shape is manufactured. The mounting rails 60 are thereafter fastened to the rear surface of the signboard 20. Thereafter, the clamp unit 32 and the coupling member 36 are rotatably coupled to each other by the second hinge shaft 54. The elastic member 58 is fitted over the second hinge shaft 54.

Furthermore, the auxiliary elastic unit 70 is provided on the upper and lower surfaces of the support unit 30. Then, the clamp unit 32 and the coupling member 36 maintain balance therebetween with respect to the leftward and rightward directions using the elastic force of the elastic member 58 and the auxiliary elastic unit 70 (see, FIG. 1). Of course, if not necessary, the auxiliary elastic unit 70 need not be provided.

As such, after the signboard 20 and the support unit 30 are manufactured, the signboard 20 and the support unit 30 are coupled to each other. At this time, as described above, the support unit 30 is mounted to the signboard 20 using the locking bolts 62 and the locking nuts 64.

In detail, the heads 62′ of the locking bolts 62 are inserted into the corresponding mounting rails 60 through the upper ends or the lower ends of the mounting rails 60. Subsequently, the screw parts 62″ of the locking bolts 62 are inserted into the corresponding coupling holes 36′a in the clamp unit 32. The locking nuts 64 are tightened over the corresponding screw parts 62″ of the locking bolts 62, thus completing the coupling of the clamp unit 32 to the signboard 20.

Subsequently, the support unit 30 is fastened to the crossbar 12.

Here, the soft member 34 is first fitted over the crossbar 12, and the upper clamp 32′ and the lower clamp 32″ surround and cover the circumferential outer surface of the soft member 34.

In detail, because the lower clamp 32″ is coupled to the upper clamp 32′ by the hinge, when the coupling bolt 38 is not tightened into the coupling nut 38′, the lower clamp 32″ is rotated around, and hangs downwards from, the first hinge shaft 46.

In this state, the crossbar 12, which is wrapped with the soft member 34, is disposed below the upper crossbar holding part 32′a of the upper clamp 32′. Thereafter, the left end of the lower clamp 32″ is rotated upwards such that the left end of the upper clamp 32′ and the left end of the lower clamp 32″ are adjacent to each other. Subsequently, the coupling bolt 38 is inserted into a clamp coupling hole 32c′, and is tightened into the coupling nut 38′.

Then, the upper clamp 32′ and the lower clamp 32″ firmly clamp the crossbar 12 using the coupling force between the coupling bolt 38 and the coupling nut 38′. The installation of the signboard assembly 10 of the present invention is completed through the above-mentioned processes. As shown in FIG. 1, after the installation of the signboard assembly 10 has been completed, the signboard 20 maintains its vertical orientation relative to the ground.

Meanwhile, the weight member 80 may be optionally provided depending on the selection of a user. The weight member 80 is inserted into the weight member bracket 82 through one of the upper end, the front end or the rear end thereof (when seen in FIG. 1). The weight member 80, which is inserted into the weight member bracket 82, is held in the weight member bracket 82 by the locking screws 86.

In the state in which the installation of the signboard assembly has been completed, when external force is applied to the signboard 20, the signboard 20 is rotated around the second hinge shaft 54. That is, the clamp unit 32 is firmly fastened to the crossbar 12, and the signboard 20 and the coupling member 36 are rotatably coupled to the clamp unit 32 by the hinge. Hence, the signboard 20 is rotatable around the second hinge shaft 54.

Of course, when a relatively small external force (wind or a collision of a vehicle) is applied to the signboard 20, it need not rotate. That is, the elastic member 58 and the auxiliary elastic unit 70 are provided in the support unit 30, and the elastic member 58 and the auxiliary elastic unit 70 prevent the rotation of the signboard 20 and the coupling member 36.

However, in the case where an external force beyond a predetermined magnitude is applied to the signboard 20, the signboard 20 is rotated around the second hinge shaft 54 in a clockwise or counterclockwise direction (as seen in FIG. 1). In other words, when the external force that is applied to the signboard 20 is greater than the force of the elastic member 58 and the auxiliary elastic unit 70, the signboard 20 is rotated.

When the external force is removed from the signboard 20, the signboard 20 is returned to its original position by the elastic force of the elastic member 58 and the auxiliary elastic unit 70.

Here, the rotation and the restoration of the signboard 20 are also affected by the weight member 80. Because the weight member 80 is made of a material having a relatively high specific gravity, in the case where the weight member 80 is provided on the lower end of the signboard 20, the load of the lower part of the signboard 20 is relatively high.

Therefore, the signboard 20 tends to maintain its vertical orientation relative to the ground due to the load of the lower part thereof, as shown in FIG. 1. In this state, even when an external force is applied to the lower part of the signboard 20 in a leftward or rightward direction (as seen in FIG. 1), the signboard 20 tends to maintain the original position thereof.

Furthermore, when a relatively large external force is applied to the signboard 20, the signboard 20 is rotated, but, when the external force is removed therefrom, the signboard 20 can be rapidly returned to its original position by the load of the weight member 80.

The bounds of the present invention are not limited to the embodiment disclosed above, and those skilled in the art can variously modify the embodiment within the scope and spirit of the above-mentioned techniques based on the present invention.

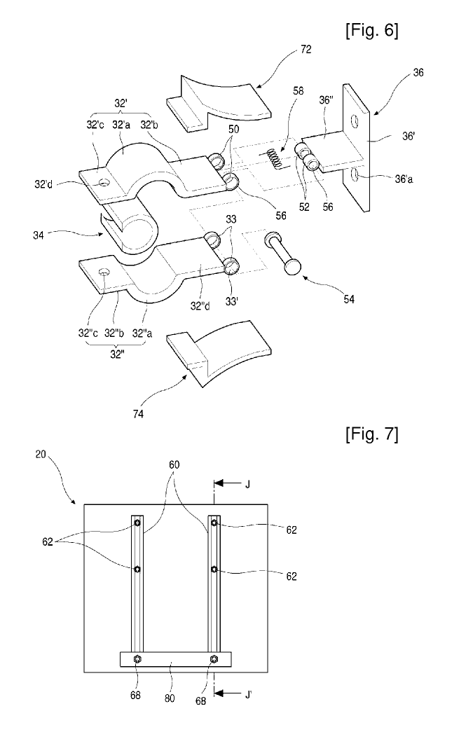

FIG. 6 illustrates another embodiment of a support unit according to the present invention.

In this embodiment, an upper clamp 32′ and a lower clamp 32″ have corresponding shapes and are symmetrically arranged. In detail, the right end of a lower crossbar holding part 32″a of the lower clamp 32″ extends rightwards to form a lower extension part 32″d. The lower extension part 32″d has a shape corresponding to the upper extension part 32′b of the upper clamp 32′, and they are in close contact with each other.

Furthermore, a pair of hinge bushes 33 is provided on the right end of the lower extension part 32″d. The hinge bushes 33 have shapes and sizes corresponding to those of hinge bushes 50. Hinge holes 33′, which have the same diameter as hinge holes 56, are formed through the centers of the hinge bushes 33.

The hinge bushes 50 and hinge bushes 52 are disposed between the hinge bushes 33. A hinge shaft 54 is inserted through the hinge bushes 33, the hinge bushes 50 and the hinge bushes 52.

Thus, the upper clamp 32′ and the lower clamp 32″ are rotatable around the hinge shaft 54. Therefore, the installation of the upper clamp 32′ and the lower clamp 32″ around the crossbar 12 is facilitated.

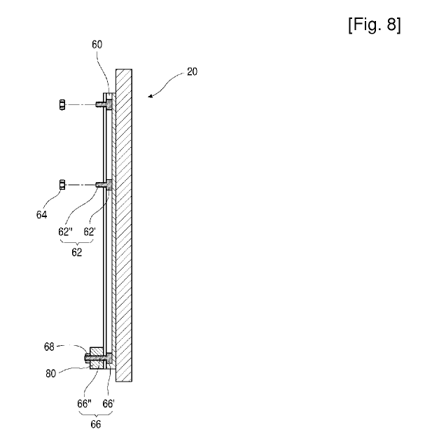

FIGS. 7 and 8 illustrate another embodiment of the installation of a weight member 80 according to the present invention.

As shown in these drawings, in this embodiment, the weight member 80 is fastened to mounting rails 60 rather than being mounted to the signboard using the weight member bracket 82.

In detail, the mounting rails 60 extend to the lower end of the signboard. The weight member 80 is mounted to the mounting rails 60. For this, weight member coupling bolts 66 and weight member coupling nuts 68 for holding the weight member 80 are provided in the lower end of the weight member 80.

Each weight member coupling bolt 66 includes a head 66′, which is fitted into the corresponding mounting rail 60 in the same manner as the locking bolt 62, and a screw part 66″, which is inserted through the weight member 80. Each weight member coupling nut 68 is tightened over the left end (as seen in FIG. 8) of the screw part 66″ of the corresponding weight member coupling bolt 66. In this construction, the weight member 80 is mounted to the signboard without using the separate weight member bracket 82.

Although the preferred embodiments of the present invention have has been disclosed for illustrative purposes, those skilled in the art will appreciate that various modifications, additions and substitutions are possible, without departing from the scope and spirit of the invention. Therefore, such modifications, additions and substitutions must be regarded as falling within the bounds of the accompanying claims of the present invention.

1. A signboard assembly, comprising:
a signboard for indicating an information;
a support unit for rotatably supporting the signboard;
an elastic member for applying an elastic force to the support unit to return the support unit to an original state thereof, and
an auxiliary elastic unit provided on the support unit to apply an elastic force to the support unit to return the support unit to an original position thereof.

2. The signboard assembly according to claim 1, wherein the support unit comprises:
a clamp unit fastened to a crossbar; and
a coupling member coupled to the clamp unit so as to be rotatable, the coupling member being coupled at an end thereof to the signboard.

3. The signboard assembly according to claim 2, further comprising:
a soft member provided between the clamp unit and the crossbar, the soft member having a predetermined elasticity and surrounding the crossbar.

4. A signboard assembly, comprising:
a signboard for indicating an information;
a support unit for rotatably supporting the signboard;
an elastic member to apply an elastic force to the support unit to return the support unit to an original position thereof; and
a weight member provided on a lower end of the signboard to maintain an original installation position of the signboard.

5. The signboard assembly according to claim 4, wherein the support unit comprises:
a clamp unit fastened to a crossbar;
a coupling member coupled to the clamp unit so as to be rotatable, the coupling member being coupled at an end thereof to the signboard; and
a soft member provided between the clamp unit and the crossbar, the soft member being made of an elastic material.

6. The signboard assembly according to claim 4, further comprising:
an auxiliary elastic unit provided at a predetermined position on the support unit to apply an elastic force to the support unit to return the support unit to an original position thereof.

7. The signboard assembly according to claim 6, wherein the elastic member comprises an elastic spring.

8. The signboard assembly according to claim 5, wherein the clamp unit comprises:
an upper clamp provided at an upper position; and
a lower clamp provided at a lower position, wherein the upper clamp and the lower clamp are coupled at one ends thereof to each other by a hinge.

9. A signboard assembly, comprising:
a signboard for indicating an information;
a support unit for rotatably supporting the signboard; and
a weight member provided on the signboard to maintain an original installation state of the signboard.

10. The signboard assembly according to claim 9, wherein the weight member is removably mounted to a lower end of the signboard.
